(19) United States
(12) Patent Application Publication
(10) Pub. No.: US 2010/0168965 A1
(43) Pub. Date: Jul. 1, 2010

(54) METHOD AND CONTROL DEVICE FOR TRIGGERING PASSENGER PROTECTION MEANS

(76) Inventors: Alfons Doerr, Stuggart (DE); Marcus Hiemer, Kehlen (DE)

Correspondence Address: KENYON & KENYON LLP, ONE BROADWAY, NEW YORK, NY, 10004, US

(21) Appl. No.: 12/452,153

(22) PCT Filed: Jun. 13, 2008
(86) PCT No.: PCT/EP2008/057491

§ 371 Date: Mar. 9, 2010

(30) Foreign Application Priority Data
Jun. 29, 2007 (DE) 102007030313.2

(51) Int. Cl. G06F 19/00

(52) U.S. Cl. 701/45

(57) ABSTRACT

In a method for triggering a passenger protection arrangement for a vehicle, a feature vector including at least two features is determined, the two features being derived from at least one signal of an accident sensor system. The feature vector is classified as a function of a comparison with at least one class boundary. The passenger protection arrangement is triggered as a function of the classification. A confidence measure is determined as a function of a position of the at least one feature vector in relation to the at least one class boundary. The triggering of passenger protection arrangement takes place as a function of this confidence measure.

### BACKGROUND OF THE INVENTION

1. Field of the Invention

The present invention relates to a method and a control device for triggering passenger protection means for a vehicle.

2. Description of Related Art

A method for triggering passenger protection means is already known from published German patent document DE 103 60 893 A1. In this instance, a forward displacement is determined from a signal of an acceleration sensor, and is compared with at least one threshold value, which is set as a function of a velocity reduction and a deceleration. Passenger protection means are triggered as a function of the comparison. Furthermore, it is known from this laid open print that there is already an additional method for triggering passenger protection means, in which a variable threshold is set for an integrated acceleration value as a function of parameters characterizing the crash process. Thus, it is possible to respond very precisely to the crash sequence and thus the crash type and crash severity. In particular, the variable threshold is determined as a function of the acceleration, and the speed reduction is checked against this threshold.

### BRIEF SUMMARY OF THE INVENTION

In contrast, the method and the control device according to the present invention for triggering passenger protection means for a vehicle having the features of the independent claims have the advantage that now a confidence measure is determined as a function of the classification of a feature vector, and the triggering occurs as a function of the confidence measure. Thus, the triggering of the passenger protection means is derived from a reliable basis and is also more dependable. The confidence measure may ensure different aspects of the triggering algorithm.

In the case at hand, triggering refers to activating passenger protection means, such as airbags, belt tighteners, roll bars, but also active passenger protection means such as braking and a vehicle dynamics control.

Accident sensor system refers to all known accident sensors and combinations thereof that may be distributed in the vehicle or disposed in the control device. This includes acceleration sensor systems, air pressure sensor systems, structure-borne noise sensor systems, driving dynamics sensor systems, and, in particular, surroundings sensor systems. Features may be derived from the signal of this accident sensor system, for example, the acceleration signal itself and the structure-borne noise signal itself from the acceleration signal by appropriate filtering, and the velocity, for example, by integrating the acceleration signal, and the forward displacement, for example, through duplicate integration. Thus, four signals may be derived from the acceleration signal, and additional features may be derived through further processing of the structure-borne noise signal. From these, it is possible to form a feature vector. A feature vector refers to the generation of at least two features. At least one of the features is derived from the signal of the accident sensor system. For example, the second feature may also be the time, for example, how long the triggering algorithm has been active.

To classify means that, with regard to its position, the feature vector is assigned to a class, which is specified a priori. This class is defined by class boundaries, which may be threshold values, surfaces, or other higher-dimensional boundaries. This is a function of the dimension of the feature vector. The respective class results in corresponding consequences, the triggering of passenger protection means, for example, and in particular when and which ones.

The position of the at least one feature vector is defined with regard to the zero point, on a space that is spanned by the features. The class boundaries are specified a priori, with the aid of test and/or simulation data, for example.

The confidence measure is understood as a measure that defines in a specified manner the feature vector's distance from the class boundary. The larger the confidence measure, the more reliable the classification. As illustrated above, the signal of the accident sensor system changes over time, depending on which crash sequence occurs. This then results in changing features and thus in a changing position of the feature vector in relation to the class boundary. However, it is possible to estimate whether or not the classification is particularly reliable based on the position at a predefined time. Empirical values are used for this purpose.

In the case at hand, a control device is understood as a module into which a sensor signal enters or which itself has a sensor that provides the sensor signal and, as a function of the sensor signal, outputs the control signal for the passenger protection means. Normally, the control device has a housing that accommodates the components of the control device. This housing may be made of plastic and/or metal, aluminum, for example.

The interface may be designed as hardware and/or software. In a hardware design, integrated circuits or discrete components or combinations of the two may be considered. However, it is also possible to design this interface as software, for example, on a processor.

The evaluation circuit is normally a microcontroller or another processor. However, it may also be an integrated circuit, which may carry out the specified evaluation procedures. In this context, it may be an ASIC. It is possible to use more than one processor, or also discrete components or combinations of the forms mentioned.

The feature module may be a part of the evaluation circuit, that is, it may exist in hardware form or as a software module. The same is true for the classification module and other software elements, like the confidence measure determination module and the control module.

It is advantageous that the further classification of the feature vector is performed as a function of the confidence measure. Since the triggering does not occur immediately when one feature vector is in a class, which causes a triggering of the passenger protection means, but rather a plurality of consecutive feature vectors must be in this class in order to bring about the triggering decision, the confidence measure is advantageously used to configure this classification efficiently. Thus, in an advantageous manner, run time of the algorithm may be saved, because a decision regarding the reliability of the classification is made as a function of the position of the feature vector in relation to the class boundary. If the classification is particularly reliable, then the probability is high that subsequent classifications will also lead to this classification result. In other words, this means that it does not matter whether the module is calculated or not—it always provides the same information. However, if the distance to the class boundary is short, then the probability is high that the class boundary may subsequently be undershot by the additional classification processes. In this context, it is to be taken into account that the triggering decision is made only when the class boundary has been exceeded for a predefined time. Thus, isolated overruns, as may occur in the event of a hammer blow, for example, do not result in a triggering of passenger protection means. For this reason, over time a feature vector must exceed a class boundary for a predefined time period in order for this classification and the possibly resulting subsequent triggering to derive from a reliable basis. This is where the invention sets in, in that it specifies a confidence measure that saves run time in the event that the class boundary is exceeded by a great amount, since for a specific time the feature vectors are no longer classified, but rather the classification is viewed for this time as given. This is advantageous in particular in the event of high-speed crashes, since in those the algorithm run time is critical and the distance to the class boundary is high in a high-speed crash, so that in this instance run time of the algorithm may be saved.

The following advantages are thus obtained:
1. The algorithm provides not only the information regarding the class in which the feature vector has been classified, but it also provides a reliability, i.e., confidence of this classification.
2. As illustrated above, the method according to the present invention or the control device according to the present invention may save run time. In this manner, it is possible to save resources of the evaluation circuit, of a microcontroller, for example, and thus money.
3. The run time savings will be particularly high if it is a severe crash. In this case, the classification result is usually clear, because the distance to the class boundary and thus the confidence measure is high. However, in this instance, as indicated above, the run time problem is also greatest, since the algorithm is fully utilized to capacity and many igniters must be ignited simultaneously and possibly without delay and the triggering of the passenger protection means also requires much run time. By this means, in such cases when the run time is critical, the run time gained may increase the system stability, since it becomes less likely that watchdog errors will occur when the real-time time slot is exceeded.

It is advantageous that the further classification is suspended as a function of the confidence measure. That is, if a high confidence measure exists, the classification is very reliable and the further classification of the feature vector may be suspended without incurring a loss of information.

It is furthermore advantageous that the confidence measure is only determined if a predefined number of consecutive feature vectors lead to a similar result in a comparison with the at least one class boundary. That is, the classification must have existed for a predefined number of sequential feature vectors in order to have to determine the confidence measure at all. This allows for the confidence measure calculation to be carried out only when the classification result has also stabilized. This gives the method and the control device according to the present invention greater reliability.

The confidence measure is advantageously determined when at least one of the features has exceeded a predefined threshold value. This feature may be the forward displacement, for example.

The confidence measure may advantageously be determined through a Euclidian distance or a Mahalanobis distance, which includes the covariance of the signals, or using other distance features that contain statistical information about the underlying crash signal. The Euclidian distance is familiar to anyone skilled in the art, while the Mahalanobis distance, as indicated above, also includes the covariance of the signals. The Mahalanobis distance is a statistical distance measure that is used in particular in multivariate distributions, thus when the distribution function is made up of different “individual distribution functions.” The distance of two points x and y distributed in this manner is then determined through the Mahalanobis distance

$$d ( x , y ) = \sqrt{{( x - y )}^{T} S ( x - y ) ) ,}$$

S corresponding to the covariance matrix. The points at an identical Mahalanobis distance from a center graphically form a twisted and distorted ellipsis in two dimensions, while in the case of the Euclidian distance it is a circle. If the covariance matrix is the unit matrix (this is the case precisely when the individual components of the random vector X are independent in pairs and respectively have variance 1), then the Mahalanobis distance corresponds to the Euclidian distance. The Mahalanobis distance may thus be used when information about the statistical distributions of the features exists. Another frequently used distance measure is the Lₚ distance

$${L}_{p} ( x , y ) = \sqrt[p]{{\sum }_{i = 1}^{n} {\vert {x}_{i} - {y}_{i} \vert}^{p}} , x , y , ∈ {R}^{n} , p ∈ N$$

or distance measures derived therefrom.

It is furthermore advantageous that an estimation module, which may also be designed as hardware and/or software, like the other above-mentioned modules, determines as a function of the confidence measure how long the further classification is suspended. In this instance as well, empirical knowledge is included in order to determine on the basis of the distance, that is, the length of the distance, how reliable the classification is and thus how long the further classification may be suspended. The direction in which the feature vector develops relative to the characteristic curve is also included. If it moves in a manner perpendicular to the separating line, then it is to be assumed that the reliability of the confidence measure is higher.

In order to determine this value of how long the classification may be suspended, the confidence measure, that is, the Euclidian distance, for example, is examined in relation to a maximum change of the at least two features that are used. This maximum change is known a priori from experience and/or analytical considerations. An example of an analytical consideration: if the maximum change of a feature is restricted by the measuring range of a sensor: if an acceleration sensor has a minimum value of −120 LSB, then the integrated acceleration may change at most by −360 LSB within three cycles. If the distance to the separating line is 400 LSB, then purely based on physics the threshold cannot be undershot, and the calculation of this function may be suspended for three cycles.

It is furthermore advantageous that the classification of the feature vector is performed by different additional functions, which are allocated to different sensor signals, for example. The respective confidence measures are determined for these different feature vectors of the different sensor signals, and then the respective additional function may be switched off as a function of the confidence measure. Thus, this is in particular a great advantage in a modularly structured triggering algorithm for passenger protection means.

It is furthermore advantageous that a computer program exists that executes all steps of the method according to one of the method claims when it runs on a control device, as specified above. The computer program may be written in a high-level language, such as C, C++, etc., and is then translated into a machine-readable code. It is furthermore advantageous that a computer program exists that has a program code that is stored on a machine-readable carrier for a semiconductor memory, an optical and/or a magnetic memory and is also used to implement the method according to the present invention. In this instance as well, the program is to be executed on a control device.

### BRIEF DESCRIPTION OF THE SEVERAL VIEWS OF THE DRAWING

FIG. 1 shows a block diagram of the control device according to the present invention having connected components.

FIG. 2 shows a software structure of the microcontroller.

FIG. 3 shows a flow chart of a method according to the present invention.

FIG. 4 shows a signal flow chart in accordance with the present invention.

FIG. 5 shows a feature diagram having two feature vectors.

FIG. 6 shows an additional signal flow chart.

FIG. 7 shows an additional feature diagram.

FIG. 8 shows an additional feature diagram.

FIG. 9 shows a first time diagram in accordance with the present invention.

FIG. 10 shows a second time diagram in accordance with the present invention.

### DETAILED DESCRIPTION OF THE INVENTION

FIG. 5 shows a two-dimensional feature space, which is spanned by features M1 and M2. Two feature vectors x1 and x2 are indicated and also a classification boundary 500, in the case at hand as a threshold value. In region 501, which corresponds to a class, the passenger protection means are triggered, while in region 502, which corresponds to an additional class, the passenger protection means are not triggered. Instead of the triggering, an add-on value may also be output, which changes another characteristic curve or even loads another characteristic curve.

The drawing illustrates that feature vector x1 cannot result in a high confidence measure regarding its classification, since even a small change to both features may result in a modified classification, while vector x2 will result in a much higher confidence measure due to its position, since a small change to the features will not result in a change in the classification. This points out the advantage of the present invention.

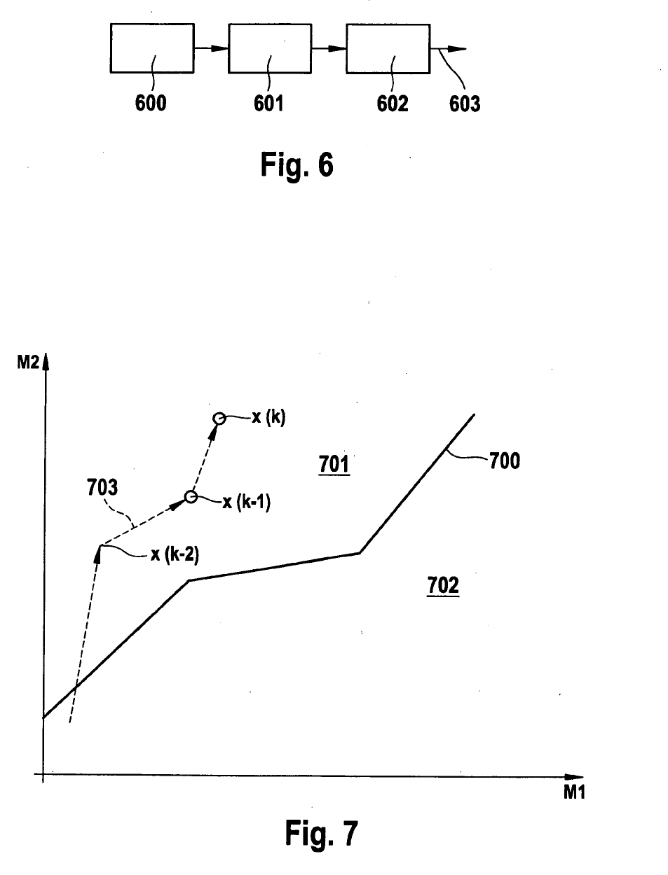

FIG. 6 explains in a signal flow chart the main steps that may be performed in the method according to the present invention. The features are determined in method step 600 and then the feature vector is formed from the features. This is then used to perform the classification. The confidence measure determination according to the present invention takes place in method step 601. In method step 602, the length of time for which the algorithm may be suspended is estimated. Method step 603 proceeds to a control module that suspends the algorithm with regard to the classification as a function of the result of the estimation.

This will be explained in detail now. The feature calculation in method step 600, and the formation of the feature vector and the classification, are performed in the known manner, speed reduction dv being determined from the acceleration signal, as indicated above, for example, namely through simple integration, where in the case at hand integration is to be understood pragmatically. Thus, a vector from the acceleration as a first feature and speed dv as a second feature is available. This vector is entered in the two-dimensional feature diagram and compared to the class boundary, which then exists as a threshold value. It may thus be determined whether the feature vector results in a call for a triggering operation, or not.

FIG. 7 shows a two-dimensional feature diagram, feature M1, for example, the acceleration, lying on the abscissa, and feature M2, for example, the speed, lying on the ordinate. A threshold value 700 is specified as the class boundary. Threshold value 700 divides two classes 701 and 702 in the diagram. Class 701 is the triggering cases and class 702 the non-triggering cases. The temporal development of the feature vector is shown by 703. The oldest vector, vector x(k−2), the next youngest vector, vector x(k−1), and current vector x(k) illustrate the development of the feature vector in relation to threshold value 700. All three lie above threshold value 700 and thus in class 701 and therefore call for a triggering of the passenger protection means. One above-mentioned development specifies that the confidence measure is determined only if the feature vector lies above threshold value 700 for a predefined number of points in time. In the case at hand, this number is 3, and thus is provided according to FIG. 7. The confidence measure is thus determined for vector x(k). Outliers are excluded by this perspective over time.

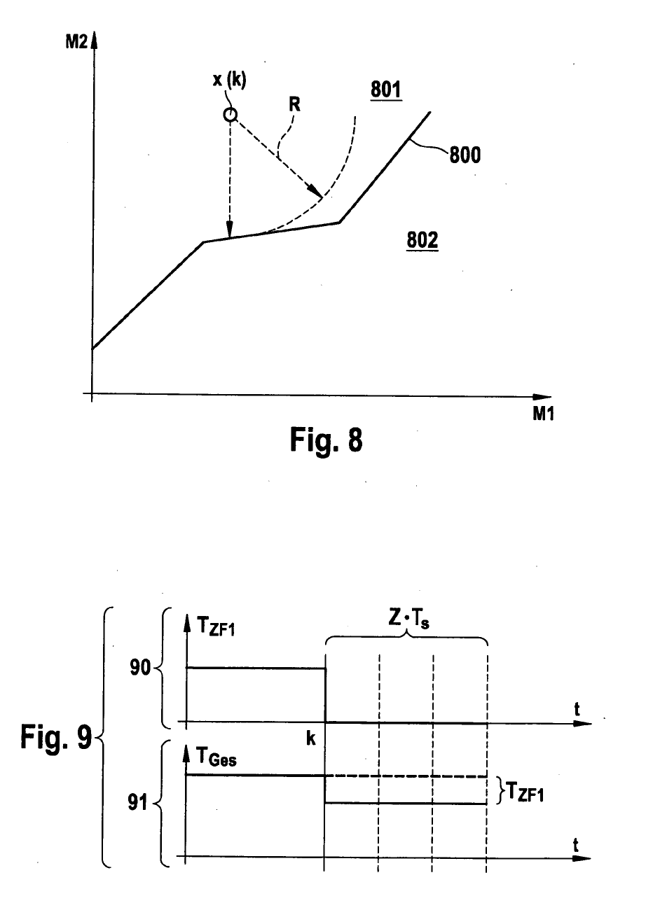

FIG. 8 likewise illustrates threshold value 800 in the feature diagram and classes 801 and 802, which correspond to classes 701 and 702. In this case, however, only vector x(k) is shown, for which the confidence measure is to be determined. Here, the threshold value is divided into three regions, g1, g2, and g3. In this case, the confidence measure is determined using Euclidian distance R. Euclidian distance R of vector x(k) is calculated using a straight line g:y=a+χb in the following manner:

$$R = \frac{\vert bx ( x - a ) \vert}{\vert b \vert} \qquad ( 1 )$$

Alternatively, it is possible, as specified above, to use the Mahalanobis distance, which includes the covariance of the signals, or to use another distance feature, which contains statistical information about the underlying crash signal to determine the confidence measure.

In step 602, an estimation module determines the number of real-time cycles for which a calculation may be omitted in the classification. Assuming that signal M1 may change by a maximum of M1 in one cycle, and signal M2 by a maximum of ΔM2, then the following inequation describes how many cycles Z may pass before the threshold line may be crossed again theoretically:

$$\sqrt{( {( Z \cdot Δ {M}_{1} )}^{2} + {( Z \cdot Δ {M}_{1} )}^{2} )} ) \leq R ⇒ Z = \frac{R}{\sqrt{{( Δ {M}_{1} )}^{2}} + {( Δ {M}_{2} )}^{2}} \qquad ( 2 )$$

In control device SG, figure Z determined in equation 2 must still be rounded down. Thus, Z describes the time period in real-time cycles, for which it is possible to omit a calculation and an evaluation of features M1 and M2.

To avoid calculating the root in equation 2, the following simplified inequation may be evaluated:

(Z₁·ΔM₁≦R)&(Z₂·ΔM₂^{≦R}) [symbol] Z=min(Z₁,Z₂) (3)

Figure Z from equation 3 would also have to be rounded down for use in the control device. However, the results according to equation 3 are possibly significantly less precise than those according to equation 2.

The control module takes over the control of the algorithm processing. If it is assumed that features M1 and M2 according to FIGS. 7 and 8 are calculated using additional function ZF1, then the following picture results for the run-time development at time k as shown in FIG. 9, which illustrates the run-time gain from switching off the calculation of additional function ZF1 for the next Z real-time cycles Z·ts. This is illustrated in upper diagram 90, while the total time is illustrated in lower diagram 91. When additional function ZF1 is switched off, the run-time at the level of T_{ZF1} is gained. This gained run-time may be used to connect additional functionalities, since the total real-time algorithm run-time T_{Ges} is reduced by T_{ZF1}. In cases when the run time is critical, the run time gained may increase the system stability, since it becomes less likely that watchdog errors will occur when the real-time time slot is exceeded.

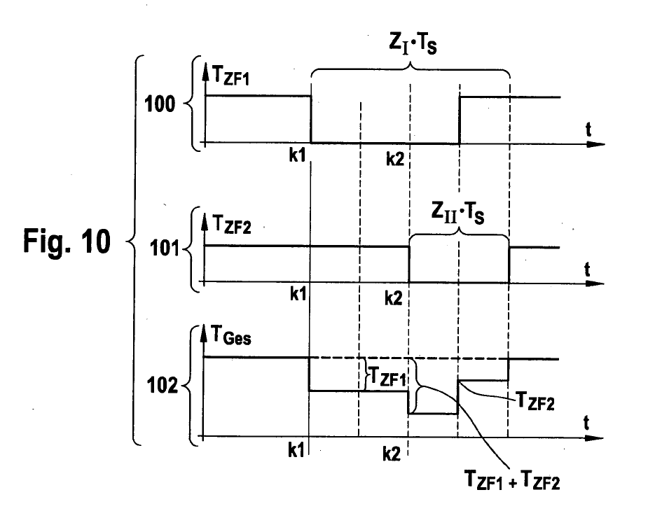

The method according to the present invention may be used for different functions. In a triggering algorithm, a plurality of additional functions may be evaluated at the same time, for example. In the present context, this is understood pragmatically, i.e., if only one computer is present, then a simultaneous evaluation in the sense of a time slice model is conceivable, for example. For each of these additional functions, a calculation is then made regarding how long the call of this additional function may be suspended. Then, at each point in time, the control module would check to see which of the additional functions must be called up in the current real-time cycle. If a plurality of calls are blocked by the evaluating of the confidence measure, then the sum of the individual run-times of the additional function is the resulting gain in run-time. This follows from FIG. 10. At time k1, the calculation of additional functions ZF1 is suspended for Z_{I}·Tₛ. Also, starting from time k2, the calculation of additional function ZF2 is suspended for Z_{II}·Tₛ−
cycles. The result of this is that in accordance with FIG. 10
for k1≦t≦k2, the total run time of the algorithm is reduced by T
for k2<t<k1+Z_{I}·Tₛ, the total run time of the algorithm is reduced by ZF1+ZF2, and
for k1+Z_{I}·Tₛ<t<k2+Z_{II}·Tₛ, the total run time of the algorithm is reduced by ZF2.

In FIG. 10, the activity of function ZF1 is illustrated in diagram 100, i.e., if the value is above zero, then the additional function is executed and if the value is equal to zero, then it is suspended. Accordingly, the activity for function ZF2 is illustrated in diagram 101, and the activity for the total algorithm in diagram 102, in this instance the height of the amplitude representing the sum of the functions respectively.

The gained run time may in turn be used in the determination of other functionalities. If this is not possible, then the run time gain may be used in cases where run time is critical to reduce the probability of a watchdog error. To wit, if a high confidence measure is determined, then module X, in which the confidence measure is determined, may be switched off, since it may then be concluded that there is a high remaining run time in the total airbag system. In situations that are critical to run time, the watchdog strikes precisely at the moment when the total system run time is above 500 μs frequently in succession. The run-time saved by the fact that module X does not calculate thus reduces the probability of a watchdog error, because timeouts of the 500 μs boundary will become less likely.

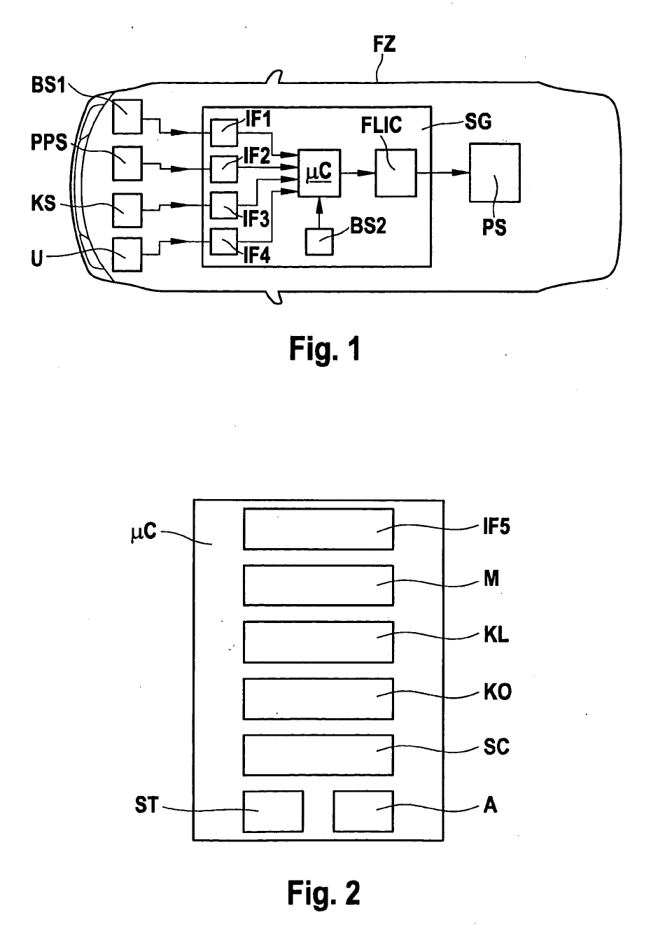

FIG. 1 shows a block diagram of the control device according to the present invention in vehicle FZ having connected components. Control device SG receives signals from different accident sensor systems BS1 (an acceleration sensor system), PPS (an air-pressure sensor system), KS (structure-borne noise sensor system) and U (a surroundings sensor system), and these signals are used to determine whether passenger protection means PS are to be triggered or not. A driving dynamics sensor system may also be used.

For example, acceleration sensor system BS1 is implemented as a side-impact sensor system and/or upfront sensor system, i.e., on the front of the vehicle, separate from the control device, to detect impact situations particularly early. In this instance, acceleration sensor system BS1 is connected to interface IF1, namely in the present case via a unidirectional data transmission from acceleration sensor system BS1 to interface IF1. In this case, interface IF1 is provided as an integrated circuit, and it transmits the acceleration signals in a format that is suitable for microcontroller μC in control device SG, for example, via the so-called SPI (serial peripheral interface) bus, so that microcontroller μC may process these signals in a simple manner. Accordingly, air-pressure sensor system PPS is connected to interface IF2, structure-borne noise sensor system KS to interface IF3, and surroundings sensor system U to interface IF4.

In this context, air-pressure sensor system PPS is provided for side-impact sensing. A side-impact sensor system may be used to plausibilize the air-pressure signal, since in general the air-pressure signal appears earlier than the acceleration signal. The structure-borne noise sensor system is also disposed at a suitable point in the vehicle, which may also be in control device SG itself. The structure-borne noise sensor system may also be used to plausibilize the air-pressure sensor system, for example, but also for the crash severity, or crash type recognition. The structure-borne noise sensor system is normally also an acceleration sensor system, in which the high-frequency portions are evaluated.

The surroundings sensor system may be a video, radar, lidar, and/or ultrasound sensor system, or other known surroundings sensor systems, including a capacitive sensor system, for example. An acceleration sensor system BS2 is disposed in control device SG itself, which may also be used for crash severity or plausibilization. It is directly connected to microcontroller μC, at an analog or digital input, for example. The interface is then located on microcontroller μC as a software module.

In the present case, microcontroller μC is the evaluation circuit. It evaluates the sensor signals according to the algorithm, the sensor signals being used to form features from which vectors are formed. These feature vectors are then classified in the above-described manner. For this purpose, microcontroller μC loads the necessary software elements together with the data about how or where the class boundaries run, from an EEPROM or other memories, for example. The class may also be defined by so-called support vectors, which implicitly contain the information about the class boundary and which also exist in the memory. That means that for this case, the points of the actual separating line do not have to be stored explicitly in the memory. The triggering decision is made as a function of the classification. This is then communicated to triggering circuit FLIC, which is provided as an integrated circuit, but which may also be made up of a plurality of integrated circuits or of a combination of integrated circuits and discrete components. Triggering circuit FLIC has circuit breakers, in particular, which are switched through as a function of the triggering signal of microcontroller μC, in order to enable a supply of power to the ignition elements, or an activation of the reversible actuators of the passenger protection means.

For the sake of simplicity, only the components necessary for understanding the present invention are illustrated. Additional components necessary for the operation of control device SG are omitted for the sake of simplicity.

FIG. 2 shows the software modules that may be necessary on microcontroller μC for the present invention. This includes software interface IF5, for example, which is used for the connection of the signal of acceleration sensor system BS2. Feature module M forms the features from the sensor signals, and forms the feature vector from them. As described above, different computational rules may be used to form the features. The feature vectors are then assigned to a class in classification module KL and are thus classified. The confidence measure determination module KO determines the confidence measure for the individual feature vectors, in as much as this confidence measure is to be determined already. Estimation module SC estimates on the basis of the confidence measure how long the individual functions or classifications may be suspended. This suspension is then implemented by control module ST. Module A finally transmits the triggering signal to triggering circuit FLIC.

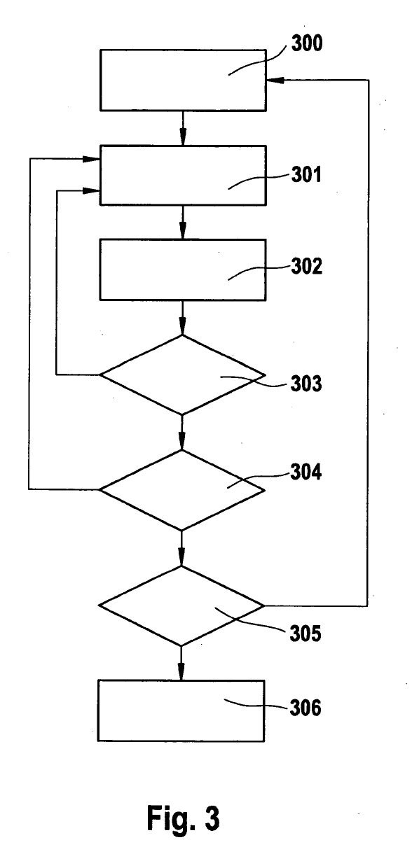

FIG. 3 explains the method according to the present invention in a flow chart. In method step 300, the signals of accident sensor systems BS1, BS2, PPS, KS and O are prepared by interfaces IF1 through 5. Then, in the microcontroller, feature module 301 forms the feature vector from the features that are obtained from the signals. Then, in method step 302, classification module KL classifies the feature vectors. The confidence measure is determined in method step 303. In method step 304, a check is carried out to see whether or not the feature vectors were already classified into a class often enough. If this is not the case, then the system returns to method step 302 for the renewed classification of the current feature vector. In the case at hand, it is readily comprehensible that method step 304 may be exchanged with g1 method step 303. However, if it was determined in method step 304 that the confidence measure and the classification were performed often enough, then in method step 305 a check is done to see whether the triggering is to take place or not. If this is not the case, then the system jumps back to method step 300 and signals from the accident sensor system are again provided for further calculations. However, if the triggering decision is made, then the system jumps to method step 306 and the passenger protection means are triggered.

The system may also jump from method step 303 or 304 to method step 300, because in the case at hand, renewed classification means that a current feature vector is classified now.

It is possible to determine how long the calculation of the module may be suspended. In this context, the scheduler that performs the deactivation of the module may be triggered.

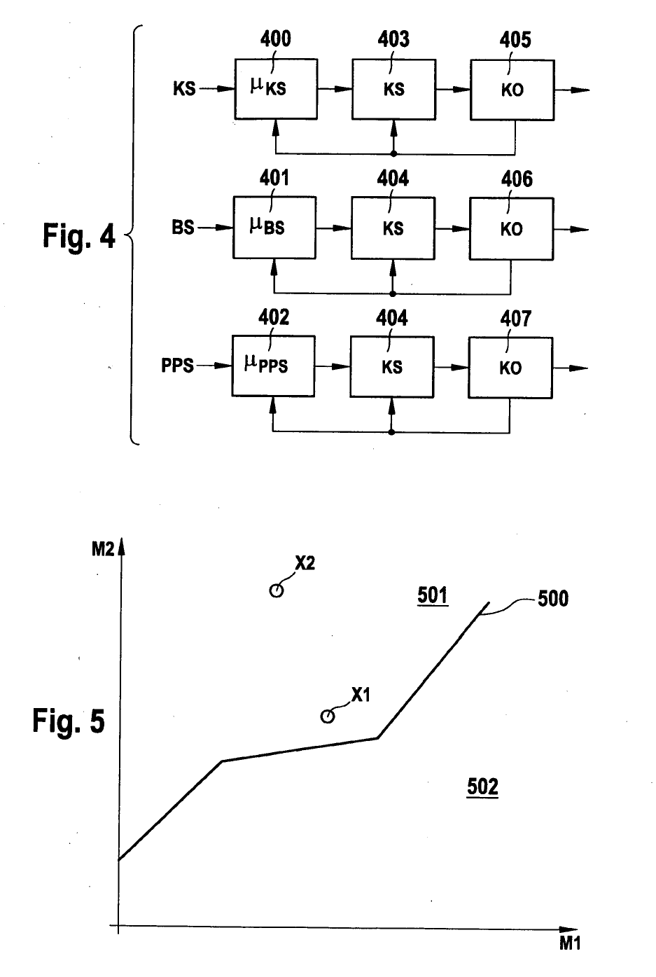

FIG. 4 illustrates that different functions exist in the algorithm, namely, depending on the sensor system that is to be implemented, for example. The first line of FIG. 4 illustrates this for the structure-borne noise sensor system, line 2 for acceleration sensor system BS, and line 3 for air-pressure sensor system PPS. The signal of structure-borne noise sensor system KS is used in block 400 to form a feature, for example, by using the structure-borne noise signal and the integrated structure-borne noise signal. This feature is used in method step 403 for a classification and in method step 405, the confidence measure is determined from the latter. This confidence measure is then furthermore used by the estimation module to estimate how often the feature classification may by suspended. However, if a greater reliability for the confidence determination is desired, then it is possible to jump back to block 400, in order to classify a current feature vector and to determine the confidence measure.

Accordingly, in line 2 this applies to acceleration signal BS, which is formed into a feature vector in block 401; a classification being carried out in block 404, and a confidence measure being formed in block 406. In line 3, this is performed accordingly for the air pressure sensor signal in blocks 402, 404, and 407.

1-11. (canceled)

12. A method for triggering a passenger protection unit for a vehicle, comprising:
determining at least one feature vector including at least two features, at least one of the two features being derived from at least one signal of an accident sensor system;
classifying the at least one feature vector as a function of a comparison between the at least one feature and at least one class boundary;
selectively determining a confidence measure as a function of a position of the at least one feature vector in relation to the at least one class boundary; and
triggering the passenger protection unit as a function of the classification and the confidence measure.

13. The method as recited in claim 12, wherein the triggering takes place as a function of a further classification of the at least one feature vector, and wherein the further classification is selectively performed as a function of the confidence measure.

14. The method as recited in claim 13, wherein the further classification is selectively suspended as a function of the confidence measure.

15. The method as recited in claim 13, wherein the confidence measure is determined only if a predefined number of consecutive feature vectors each produce a substantially similar result in comparisons with the at least one class boundary.

16. The method as recited in claim 13, wherein the confidence measure is determined by one of a Euclidian distance, a Mahalanobis distance or a distance based on statistical data.

17. The method as recited in claim 14, wherein an estimation module determines as a function of the confidence measure how long the further classification is suspended.

18. The method as recited in claim 17, wherein, in order to determine how long the further classification is suspended, the estimation module examines the confidence measure in relation to a maximum change of the at least two features.

19. The method as recited in claim 13, wherein the classification of the at least one feature vector is performed by different additional functions, and wherein the respective additional functions are selectively switched off as a function of respective confidence measures.

20. A control device for triggering a passenger protection unit of a vehicle, comprising:
at least one interface configured to provide at least one signal of an accident sensor system;
a triggering circuit configured to trigger the passenger protection unit; and
an evaluation circuit configured to generate at least one feature vector by at least one feature module, the feature vector having at least two features that the at least one feature module produces from the at least one signal, wherein the evaluation circuit classifies the at least one feature vector as a function of a comparison with at least one class boundary, and wherein the evaluation circuit has a confidence measure determination module configured to determine a confidence measure as a function of a position of the at least one feature vector in relation to the at least one class boundary, and wherein the evaluation circuit has a control module that controls triggering of the triggering circuit as a function of the classification and the confidence measure.

21. A computer-readable data storage medium storing a computer program having program codes which, when executed by a computer, implements a method for triggering a passenger protection unit for a vehicle, the method comprising:
determining at least one feature vector including at least two features, at least one of the two features being derived from at least one signal of an accident sensor system;
classifying the at least one feature vector as a function of a comparison between the at least one feature and at least one class boundary;
selectively determining a confidence measure as a function of a position of the at least one feature vector in relation to the at least one class boundary; and
triggering the passenger protection unit as a function of the classification and the confidence measure.
